(19) United States
(12) Patent Application Publication
(10) Pub. No.: US 2026/0367552 A1
(43) Pub. Date: Nov. 19, 2026

(54) HEATER CONTROLLER, IMAGE FORMING APPARATUS, AND HEATER CONTROL METHOD

(71) Applicants: Masanao Okamoto, TOKYO (JP); Shigeaki Gotoh, MIYAGI (JP)

(72) Inventors: Masanao Okamoto, TOKYO (JP); Shigeaki Gotoh, MIYAGI (JP)

(73) Assignee: ETRIA Co., Ltd., Kanagawa (JP)

(21) Appl. No.: 19/660,987

(22) Filed: Apr. 28, 2026

(30) Foreign Application Priority Data
May 14, 2025 (JP) 2025-081508

(51) Int. Cl. G03G 15/20

(52) U.S. Cl. CPC G03G 15/2039; G03G 15/2053; G03G 15/2064

(57) ABSTRACT

A heater controller includes: circuitry configured to: determine: multiple duty-cycle limiting ranges to limit change in a duty cycle of a heater from a previous control cycle to a current control cycle; a switching threshold to switch the multiple duty-cycle limiting ranges; and heater driving patterns including a portion from 0% to 100% of a half wave of an alternating current voltage applied to the heater; determine a desired duty cycle based on: the temperature data of an object to be heated; and a target temperature; select one of the multiple duty-cycle limiting ranges based on: the duty cycle in the previous control cycle; and the switching threshold; determine a duty cycle in the current control cycle based on: the duty cycle in the previous control cycle; and the duty-cycle limiting range selected.

### CROSS-REFERENCE TO RELATED APPLICATIONS

This patent application is based on and claims priority pursuant to 35 U.S.C. § 119(a) to Japanese Patent Application No. 2025-081508, filed on May 14, 2025, in the Japan Patent Office, the entire disclosure of which is hereby incorporated by reference herein.

### BACKGROUND

### Technical Field

The present disclosure relates to heater controller, an image forming apparatus, and a heater control method.

### Related Art

One type of image forming apparatus includes a heater and heater controller that controls the heater.

### SUMMARY

The present disclosure described herein provides a heater controller including: circuitry configured to: determine: multiple duty-cycle limiting ranges to limit change in a duty cycle of a heater from a previous control cycle to a current control cycle; a switching threshold to switch the multiple duty-cycle limiting ranges; and heater driving patterns including a portion from 0% to 100% of a half wave of an alternating current voltage applied to the heater; determine a desired duty cycle based on: the temperature data of an object to be heated; and a target temperature; select one of the multiple duty-cycle limiting ranges based on: the duty cycle in the previous control cycle; and the switching threshold; determine a duty cycle in the current control cycle based on: the duty cycle in the previous control cycle; and the duty-cycle limiting range selected; extract a heater driving pattern from the heater driving patterns based on the duty cycle in the current control cycle; and control the heater based on the heater driving pattern extracted.

The present disclosure described herein also provides a heater control method including: determining: multiple duty-cycle limiting ranges to limit change in a duty cycle of a heater from a previous control cycle to a current control cycle; a switching threshold to switch the multiple duty-cycle limiting ranges; and heater driving patterns including a portion from 0% to 100% of a half wave of an alternating current voltage applied to the heater; determining a desired duty cycle based on: the temperature data of an object to be heated; and a target temperature; selecting one of the multiple duty-cycle limiting ranges based on: the duty cycle in the previous control cycle; and the switching threshold; determining a duty cycle in the current control cycle based on: the duty cycle in the previous control cycle; and the duty-cycle limiting range selected; extracting a heater driving pattern from the heater driving patterns based on the duty cycle in the current control cycle; and controlling the heater based on the heater driving pattern extracted; and controlling the heater based on the heater driving pattern extracted.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus including heater controller according to an embodiment of the present disclosure;

FIG. 2 is a block diagram illustrating a configuration of the heater controller incorporated in the image forming apparatus of FIG. 1;

FIG. 3 is a flowchart of a heater driving pattern determination process performed by the heater controller of FIG. 2;

FIG. 4 is a diagram illustrating control that changes a duty-cycle limiting range limiting a change amount of a duty cycle of a heater based on a switching threshold to switch the duty-cycle limiting range when a duty cycle in a previous control cycle is smaller than a desired duty cycle in a current control cycle as illustrated in the heater driving pattern determination process of FIG. 3;

FIG. 5 is a diagram illustrating control that changes a duty-cycle limiting range limiting a change amount of a duty cycle of a heater based on a switching threshold to switch the duty-cycle limiting range when a duty cycle in a previous control cycle is larger than a desired duty cycle in a current control cycle as illustrated in the heater driving pattern determination process of FIG. 3;

FIG. 6 is a diagram illustrating control that switches a duty-cycle limiting range among three types of duty-cycle limiting ranges based on two types of switching thresholds when a duty cycle in a previous control cycle is smaller than a desired duty cycle in a current control cycle;

FIG. 7 is a diagram illustrating control that switches a duty-cycle limiting range among three types of duty-cycle limiting ranges based on two types of switching thresholds when a duty cycle in a previous control cycle is larger than a desired duty cycle in a current control cycle; and

FIG. 8 is a block diagram illustrating a hardware configuration of the heater controller.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

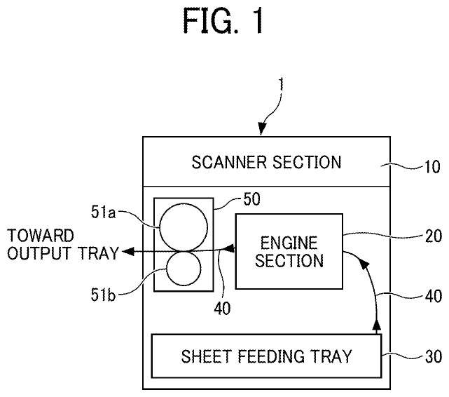

Embodiments of the present disclosure are described below with reference to FIGS. 1 to 8. To facilitate understanding of the descriptions, the same reference numerals are used as much as possible for identical components in each drawing, and redundant descriptions are omitted.

FIG. 1 is a schematic diagram illustrating a configuration of an image forming apparatus 1 including heater controller 100 according to an embodiment of the present disclosure. As illustrated in FIG. 1, the image forming apparatus 1 includes a scanner section 10, an engine section 20, a sheet feeding tray 30 to store sheets, and a fixing device 50. The scanner section 10 reads an image. The engine section 20 performs predetermined image processing on the image read by the scanner section 10 and transfers a toner image corresponding to the processed image onto a sheet. The fixing device 50 fixes the toner image onto the sheet. The heater controller 100 is disposed in the body of the image forming apparatus 1. Alternatively, the heater controller 100 may be disposed in the fixing device 50.

The scanner section 10 irradiates and scans a document with light and converts information on the document into image signals to transmit the image signals to the engine section 20.

The engine section 20 receives the image signals transmitted from the scanner section 10 and performs image processing such as color conversion and gradation correction for the image signals transmitted from the scanner section 10. In the engine section 20, an electrostatic latent image is formed on an image bearer based on image signals on which the image processing is performed, and toner is attached to the electrostatic latent image formed on the image bearer to form a toner image. A sheet is conveyed from the sheet feeding tray 30 to the engine section 20 through a conveyance path 40. The engine section 20 transfers the toner image onto the sheet and sends the sheet toward the fixing device 50 through the conveyance path 40.

After the engine section 20 transfers the toner image onto the sheet and sends the sheet toward the fixing device 50 through the conveyance path 40, heat from a fixing roller 51a having a cylindrical form and pressure from a pressure roller 51b fix the toner image onto the sheet, and the sheet is ejected toward an output tray.

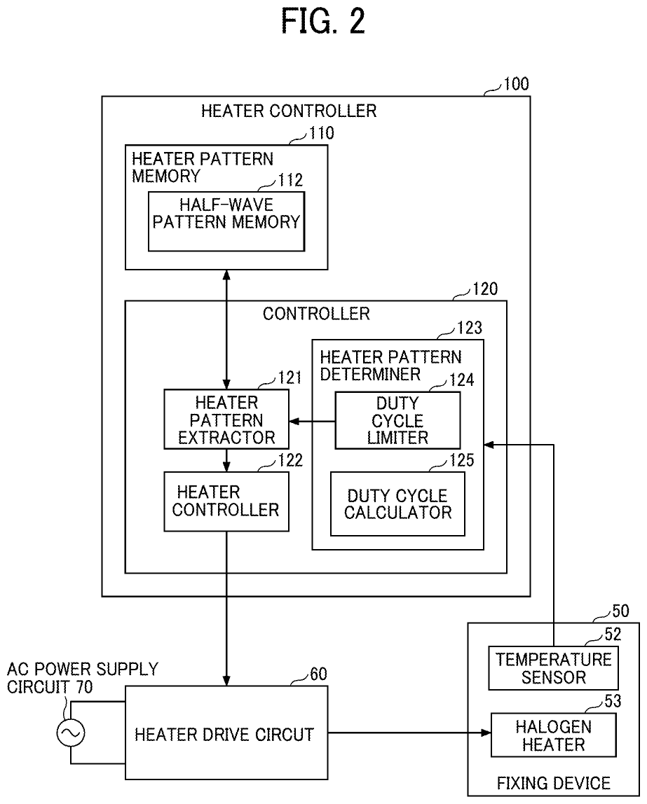

FIG. 2 is a block diagram illustrating a configuration of the heater controller 100 incorporated in the image forming apparatus of FIG. 1. As illustrated in FIG. 2, the heater controller 100 includes circuitry. The circuitry includes a heater pattern memory 110, a controller 120, and a heater drive circuit 60. The heater drive circuit 60 is coupled to an alternating current (AC) power supply circuit 70 and disposed on a board different from a board including the heater pattern memory 110 and the controller 120. As illustrated in FIG. 2, the heater controller 100 is electrically connected to the fixing device 50. The heater controller 100 controls the heat generation of a heater 53 included in the fixing device 50.

The heater 53 is an example of a heating unit. The heater 53 is disposed inside the fixing roller 51a. Heat generated by the heater 53 melts the toner image on the sheet. The toner image is embedded in fibers of the sheet and fixed onto the sheet.

Examples of the heater 53 include a halogen heater 53 as illustrated in FIG. 2. In the halogen heater 53, a halogen lamp is driven to generate radiant heat to heat the fixing roller 51a.

In addition, the fixing device 50 includes a temperature sensor 52. The temperature sensor 52 is an example of a temperature detector that detects the temperature of the surface of the fixing roller 51a. The temperature sensor 52 includes, for example, a thermistor. The resistance value of the thermistor changes depending on temperature. Based on the resistance value of the thermistor, the temperature sensor 52 measures the temperature of the surface of the fixing roller 51a. The temperature sensor 52 may be positioned inside the fixing roller 51a. Alternatively, the temperature sensor 52 may be disposed at a position facing the surface of the fixing roller 51a, not in contact with the surface of the fixing roller 51a, to measure the temperature of the surface of the fixing roller 51a.

The heater drive circuit 60 and the AC power supply circuit 70 are disposed in the image forming apparatus 1. The AC power supply circuit 70 is connected to an external commercial power source. The AC power supply circuit 70 supplies an AC voltage to the heater 53. In the present embodiment, the AC voltage varies sinusoidally over time.

The heater drive circuit 60 switches (i.e., turns on or off) the AC voltage supplied by the AC power supply circuit 70 at the timing indicated by the controller 120 and supplies the switched AC voltage to the heater 53. When the heater drive circuit 60 is turned on, the heater 53 is energized, generating heat. In contrast, when the heater drive circuit 60 is turned off, the heater 53 becomes de-energized.

The heater controller 100 according to the present embodiment determines the timing to switch the AC voltage based on input data such as the temperature of the surface of the fixing roller 51a detected by the temperature sensor 52. Based on the determined timing, the controller 120 of the heater controller 100 activates the heater drive circuit 60.

The heater controller 100 includes the heater pattern memory 110 and the controller 120.

The heater pattern memory 110 includes a half-wave pattern memory 112. The controller 120 includes a heater pattern extractor 121, heater controller 122, and a heater pattern determiner 123. In addition, the heater pattern determiner 123 includes a duty cycle limiter 124 and a duty cycle calculator 125.

The heater controller 100 controls turning on or off the halogen heater 53 in the fixing device 50 as follows. This duty cycle control is referred to as heater driving control.

Initially, the temperature sensor 52 in the fixing device 50 detects the temperature of an object to be heated, such as the temperature of the surface of the fixing roller 51a. The heater pattern determiner 123 in the controller 120 determines a duty cycle of the heater 53 as follows. The duty cycle is a factor in determining the heater driving pattern. Based on the detected temperature, the duty cycle calculator 125 in the heater pattern determiner 123 calculates a desired duty cycle to heat the fixing roller 51a to a target temperature. The target temperature is experimentally determined so that the fixing device 50 can fix the toner image onto the sheet. The duty cycle limiter 124 in the heater pattern determiner 123 limits the calculated desired duty cycle. Using the duty cycle calculator 125 and the duty cycle limiter 124, the heater pattern determiner 123 determines the duty cycle.

The half-wave pattern memory 112 in the heater pattern memory 110 stores heater driving patterns corresponding to various duty cycles. After the heater pattern determiner 123 determines the duty cycle, the heater pattern extractor 121 in the controller 120 extracts the heater driving pattern corresponding to the duty cycle determined by the heater pattern determiner 123 from the heater driving patterns in the half-wave pattern memory 112.

The heater controller 122 in the controller 120 controls the heater drive circuit 60 so that the heater drive circuit 60 turns the heater 53 on and off in accordance with the extracted heater driving pattern.

The heater drive circuit 60 couples the AC power supply circuit 70 to the halogen heater 53 to light the halogen heater 53.

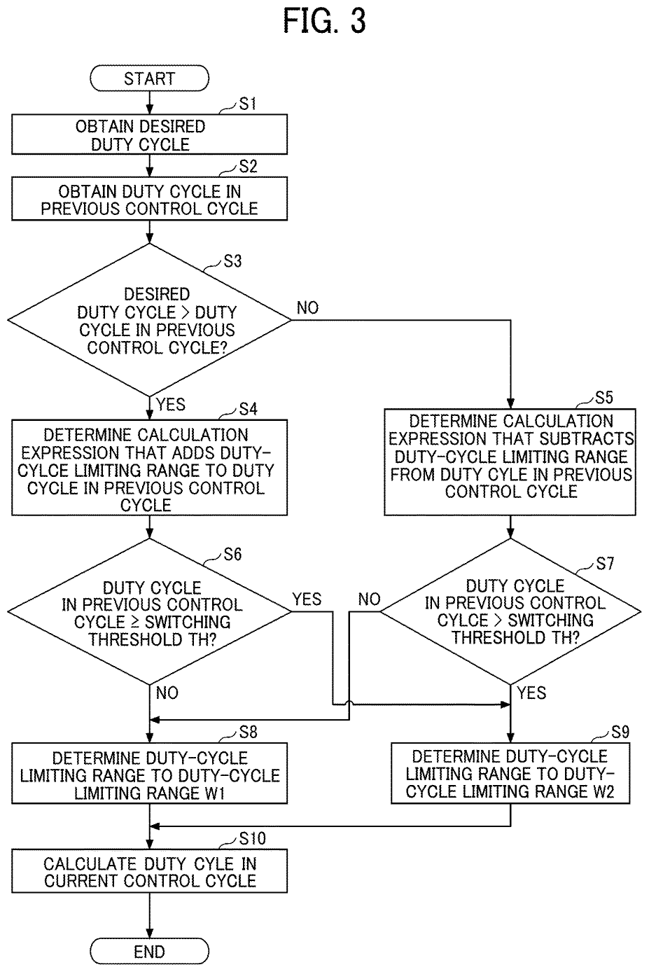

FIG. 3 is a flowchart of a heater driving pattern determination process performed by the heater controller 100. The heater pattern determiner 123 in the heater controller 100 performs steps in the flowchart of FIG. 3.

In step S1, the heater pattern determiner 123 obtains the desired duty cycle in a current control cycle calculated by the duty cycle calculator 125.

In step S2, the heater pattern determiner 123 obtains the duty cycle in a previous control cycle immediately before the current control cycle.

In step S3, the heater pattern determiner 123 determines whether the desired duty cycle obtained in step S1 is larger than the duty cycle in the previous control cycle obtained in step S2.

When the heater pattern determiner 123 determines that the desired duty cycle is larger than the duty cycle in the previous control cycle (YES in step S3), the heater driving pattern in the current control cycle is expected to have a duty cycle larger than the duty cycle in the previous control cycle. Therefore, in step S4, the heater pattern determiner 123 determines a calculation expression that adds a duty-cycle limiting range W1 or W2 to the duty cycle in the previous control cycle in order to calculate the duty cycle included in the heater driving pattern in the current control cycle. The duty-cycle limiting range W1 or W2 is a value that limits the change in the duty cycle. After performing step S4, the heater pattern determiner 123 proceeds from step S4 to step S6.

When the heater pattern determiner 123 determines that the desired duty cycle is smaller than or equal to the duty cycle in the previous control cycle (NO in step S3), the heater driving pattern in the current control cycle is expected to have a duty cycle smaller than the duty cycle in the previous control cycle. Therefore, in step 5, the heater pattern determiner 123 determines a calculation expression that subtracts the duty-cycle limiting range W1 or W2 from the duty cycle in the previous control cycle to calculate the duty cycle included in the heater driving pattern in the current control cycle. After performing step S5, the heater pattern determiner 123 proceeds from step S5 to step S7.

In step S6 after the heater pattern determiner 123 performs step S4, the duty cycle limiter 124 determines whether the duty cycle in the previous control cycle is equal to or larger than a predetermined threshold TH. The predetermined threshold TH is referred to as a switching threshold TH to change the duty-cycle limiting range. Based on the switching threshold to switch the duty-cycle limiting range, the duty-cycle limiting ranges W1 and W2 are switched, for example, from W1 to W2. The duty-cycle limiting ranges and the switching threshold to switch the duty-cycle limiting range are experimentally determined so as to maintain fixing performance and reduce an inrush current.

When the duty cycle limiter 124 determines that the duty cycle in the previous control cycle is smaller than the threshold TH (NO in step S6), the duty cycle limiter 124 proceeds to step S8. In step S8, the duty cycle limiter 124 determines the heater duty limit to be used to be the duty-cycle limiting range W1 to calculate the duty cycle in the current control cycle. The duty-cycle limiting range W1 smaller than the duty-cycle limiting range W2 reduces the inrush current. In contrast, when the duty cycle limiter 124 determines that the duty cycle in the previous control cycle is equal to or larger than the threshold TH (YES in step S6), the duty cycle limiter 124 proceeds to step S9. In step S9, the duty cycle limiter 124 determines the heater duty limit to be used to be the duty-cycle limiting range W2 to calculate the duty cycle in the current control cycle. The duty-cycle limiting range W2 larger than the duty-cycle limiting range W1 enhances the fixing performance.

In step S7 after the heater pattern determiner performs step S5, the duty cycle limiter 124 determines whether the duty cycle in the previous control cycle is larger than the above-described predetermined threshold TH that is the switching threshold TH.

When the duty cycle limiter 124 determines that the duty cycle in the previous control cycle is equal to or smaller than the threshold TH (NO in step S7), the duty cycle limiter 124 proceeds to step S8. In step S8, the duty cycle limiter 124 determines the heater duty limit to be used to be the duty-cycle limiting range W1 to calculate the duty cycle in the current control cycle to reduce the inrush current. In contrast, when the duty cycle limiter 124 determines that the duty cycle in the previous control cycle is larger than the threshold TH (YES in step S7), the duty cycle limiter 124 proceeds to step S9. In step S9, the duty cycle limiter 124 determines the heater duty limit to be used to be the duty-cycle limiting range W2 to calculate the duty cycle in the current control cycle to enhance the fixing performance.

After the duty cycle limiter 124 performs step S7 or step S9, the heater pattern determiner 123 performs step S10. In step 10, the heater pattern determiner 123 calculates the duty cycle in the current control cycle using the calculation expression determined in step S4 or step S5 and the duty-cycle limiting range W1 or W2 determined in step S8 or step S9. In the above-described calculation, the heater pattern determiner 123 sets the duty cycle in the current control cycle to the desired duty cycle when the result of adding the duty cycle in the previous control cycle to the duty-cycle limiting range W1 or W2 is equal to or larger than the desired duty cycle. Or, in the above-described calculation, the heater pattern determiner 123 sets the duty cycle in the current control cycle to the desired duty cycle when the result of subtracting the duty-cycle limiting range W1 or W2 from the duty cycle in the previous control cycle is equal to or smaller than the desired duty cycle. Completing step S10 ends the control flow.

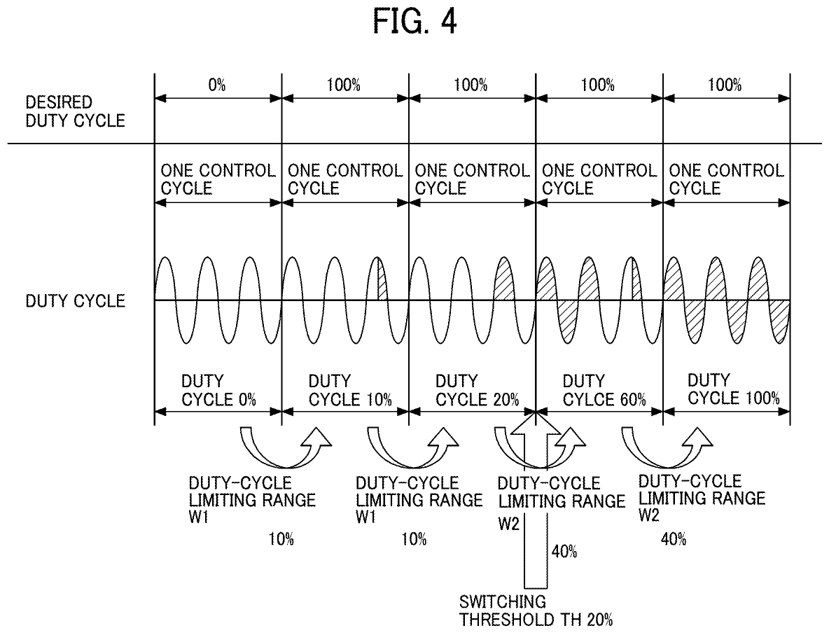

FIG. 4 is a diagram illustrating the control that changes the duty-cycle limiting range of the heater 53 based on the switching threshold TH when the duty cycle in the previous control cycle is smaller than the desired duty cycle in the current control cycle in the heater driving pattern determination process of FIG. 3.

The heater pattern determiner 123 changes the duty cycle as illustrated in FIG. 4 when the desired duty cycle in the current control cycle is larger than the duty cycle in the previous control cycle. This control limits the amount of change of the duty cycle in the heater 53 to one of the duty-cycle limiting ranges W1 and W2. The duty-cycle limiting range W1 is smaller than the duty-cycle limiting range W2. Since the inrush current is likely to increase when the duty cycle in the previous control cycle is small, the heater pattern determiner 123 determines the duty cycle in the current control cycle using the small duty-cycle limiting range W1. As a result, the control illustrated in FIG. 4 can reduce the inrush current. In addition, when the duty cycle in the previous control cycle is large, the heater pattern determiner 123 uses the large duty-cycle limiting range W2 to determine the duty cycle in the current control cycle. As a result, the duty cycle quickly reaches the desired duty cycle, which satisfies the fixing performance.

FIG. 4 illustrates an example when the heater 53 is turned on. One control cycle includes six half-waves. The desired duty cycles in the first to fifth control cycles are 0%, 100%, 100%, 100%, and 100%, respectively. In addition, in the example of FIG. 4, the switching threshold TH to switch the duty-cycle limiting range is 20%, and the two duty-cycle limiting ranges W1 and W2 that limit the change in the duty cycle are 10% and 40%, respectively.

When the heater 53 is turned on, the duty cycle in the first control cycle is 0% as illustrated in FIG. 4. At transition timings from the first control cycle to the second control cycle and from the second control cycle to the third control cycle, the duty cycle in the previous control cycle is smaller than the switching threshold TH to switch the duty-cycle limiting range that limits the change in the duty cycle. As a result, the duty-cycle limiting range W1 that is relatively smaller than the duty-cycle limiting range W2 is used, and the duty cycle is increased by 10% in each transition timing under the above-described conditions. At transition timings from the third control cycle to the fourth control cycle and from the fourth control cycle to the fifth control cycle, the duty cycle in the previous control cycle is equal to or larger than the switching threshold TH to switch the duty-cycle limiting range that limits the change in the duty cycle. As a result, the duty-cycle limiting range W1 is switched to the duty-cycle limiting range W2 that is relatively larger than the duty-cycle limiting range W1, and the duty cycle is increased by 40% in each transition timing. Finally, the duty cycle in the fifth control cycle is 100%, which is the same as the desired duty cycle.

The heater pattern determiner 123 (in particular, the duty cycle limiter 124) switches the duty cycle in one control cycle step by step without changing the control cycle and the switching threshold TH when the heater pattern determiner 123 performs the control to increase the duty cycle of the heater 53, as in the example of FIG. 4. Such a switching control that increases the duty cycle of the heater 53 step by step reduces the inrush current and shortens the time for which the temperature of the heater 53 reaches the target temperature to enhance the fixing performance of the fixing device 50.

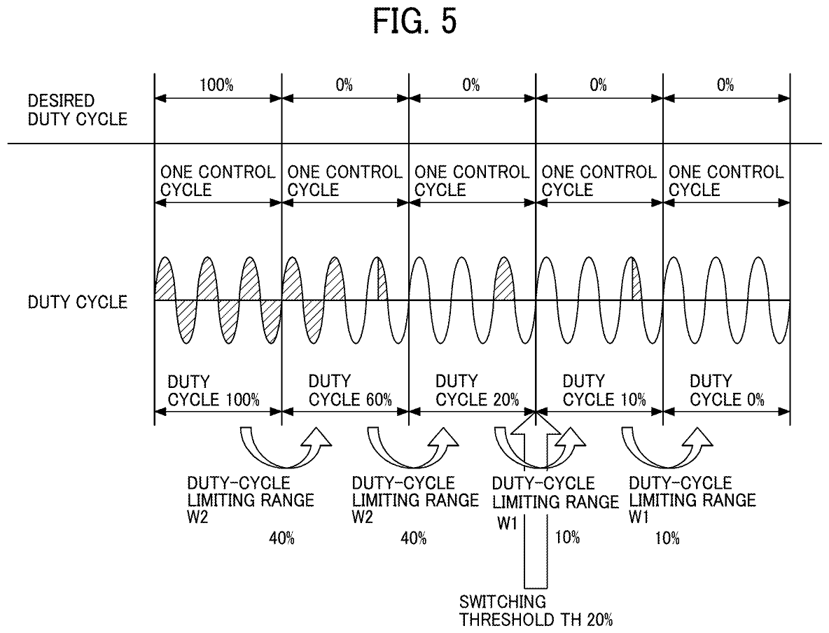

FIG. 5 is a diagram illustrating the control that changes the duty-cycle limiting range of the heater 53 based on the switching threshold TH when the duty cycle in the previous control cycle is larger than the desired duty cycle in the current control cycle in the heater driving pattern determination process of FIG. 3.

The heater pattern determiner 123 changes the duty cycle as illustrated in FIG. 5 when the desired duty cycle in the current control cycle is smaller than the duty cycle in the previous control cycle. In this control, switching the duty-cycle limiting range that limits the change of the duty cycle of the heater 53 from the relatively large duty-cycle limiting range W2 to the relatively small duty-cycle limiting range W1 reduces the occurrence of a flicker.

FIG. 5 illustrates an example when the heater 53 is turned off. One control cycle includes six half-waves. The desired duty cycles in the first to fifth control cycles are 100%, 0%, 0%, 0%, and 0%, respectively. Similarly to the example of FIG. 4, also in the example of FIG. 5, the switching threshold TH to switch the duty-cycle limiting range is 20%, and the two duty-cycle limiting ranges W1 and W2 that limit the change in the duty cycle are 10% and 40%, respectively.

When the heater 53 is turned off, the duty cycle in the first control cycle is 100% as illustrated in FIG. 5.

At transition timings from the first control cycle to the second control cycle and from the second control cycle to the third control cycle, the duty cycle in the previous control cycle is larger than the switching threshold TH to switch the duty-cycle limiting range that limits the change in the duty cycle. As a result, the duty-cycle limiting range W2 that is relatively larger than the duty-cycle limiting range W1 is used, and the duty cycle is decreased by 40% in each transition timing under the above-described conditions. At transition timings from the third control cycle to the fourth control cycle and from the fourth control cycle to the fifth control cycle, the duty cycle in the previous control cycle is equal to or smaller than the switching threshold TH to switch the duty-cycle limiting range that limits the change in the duty cycle. As a result, the duty-cycle limiting range W2 is switched to the duty-cycle limiting range W1 that is relatively smaller than the duty-cycle limiting range W2, and the duty cycle is decreased by 10% in each transition timing. Finally, the duty cycle in the fifth control cycle is 0%, which is the same as the desired duty cycle.

The heater pattern determiner 123 (in particular, the duty cycle limiter 124) switches the duty cycle in one control cycle step by step without changing the control cycle and the switching threshold TH when the heater pattern determiner 123 performs the control to decrease the duty cycle of the heater 53, as in the example of FIG. 5. Such a switching control that decreases the duty cycle of the heater 53 step by step prevents the flicker from occurring.

As illustrated in FIGS. 4 and 5, the heater pattern determiner 123 switches the duty-cycle limiting range that limits the change in the duty cycle from the small duty-cycle limiting range to the large duty-cycle limiting range when the heater pattern determiner 123 increase the duty cycle and switches the duty-cycle limiting range from the large duty-cycle limiting range to the small duty-cycle limiting range when the heater pattern determiner 123 decreases the duty cycle. When the heater 53 is turned on, the above-described control can contribute to reducing the inrush current, preventing the flicker from occurring, and enhancing the fixing performance. In addition, the above-described control can contribute to preventing the flicker from occurring when the heater 53 is turned off.

As described above, the heater controller 100 includes the circuitry. The circuitry includes the heater pattern memory 110, the controller 120, and the heater drive circuit 60. The controller 120 includes the heater pattern extractor 121, the heater controller 122, and the heater pattern determiner 123.

The circuitry stores the multiple duty-cycle limiting ranges W1 and W2, and the switching threshold TH during multiple control cycles (for example, the first to fifth control cycles). The heater pattern memory 110 in the circuitry stores the heater driving patterns each including a part of a half-wave from 0% of the half-wave to 100% of the half-wave, the half-wave of the AC voltage applied to the heater.

The control cycles are the same time and include the current control cycle and the previous control cycle immediately before the current control cycle. The duty-cycle limiting range W1 or W2 limits the change in the duty cycle of the heater from the previous control cycle to the current control cycle. The switching threshold TH is used to switch the multiple duty-cycle limiting ranges W1 and W2. The heater pattern determiner 123 receives temperature data of an object to be heated (for example, the temperature of the fixing roller 51a detected by the temperature sensor 52).

The heater pattern determiner 123 determines the desired duty cycle based on the temperature data and a target temperature (for example, a temperature to fix the toner image onto the sheet in the fixing device 50). The heater pattern determiner 123 selects the duty-cycle limiting range W1 or W2 from the multiple duty-cycle limiting ranges based on the switching threshold TH and the duty cycle in the previous control cycle and determines the duty cycle in the current control cycle based on the duty cycle in the previous control cycle and the selected duty-cycle limiting range.

The heater pattern extractor 121 extracts the heater driving pattern in the current control cycle based on the duty cycle in the current control cycle from the heater driving patterns stored in the half-wave pattern memory 112 in the heater pattern memory 110. The heater controller 122 receives the heater driving pattern in the current control cycle from the heater pattern extractor 121 and, based on the heater driving pattern in the current control cycle, controls the heater drive circuit 60 to control the heater.

The heater controller 100 described above can reduce inrush current without employing phase control and switching the control cycle and can rapidly raise the temperature of the heated object to the target temperature. Consequently, when the heater controller 100 controls the heater 53 of the fixing device 50, the fixing device 50 can exhibit excellent fixing performance, and the occurrence of inrush current is prevented.

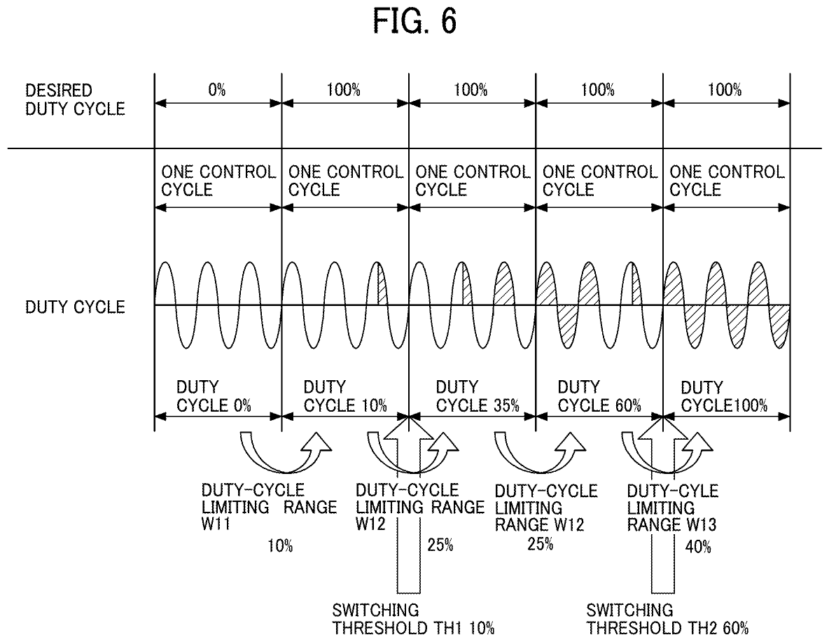

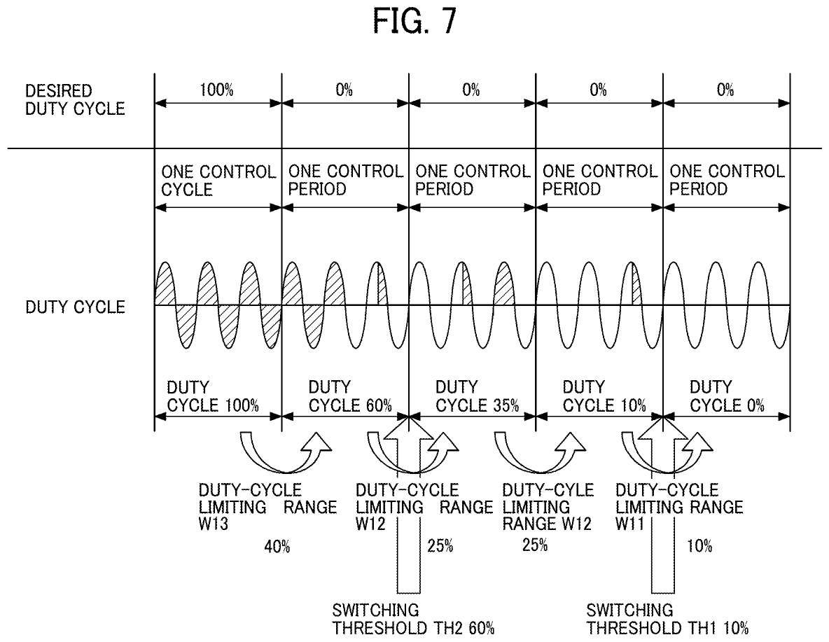

In the above-described example illustrated by FIGS. 3 to 5, the heater controller uses the two duty-cycle limiting ranges W1 and W2 that limit the change in the duty cycle of the heater 53. However, the present disclosure is not limited to this. It is enough that the heater controller may use multiple duty-cycle limiting ranges. For example, the heater controller may use three duty-cycle limiting ranges W11, W12, and W13 as the following example illustrated by FIGS. 6 and 7.

FIG. 6 is a diagram illustrating control that switches a duty-cycle limiting range among three types of duty-cycle limiting ranges W11, W12, and W13 based on two types of switching thresholds TH1 and TH2 when the duty cycle in the previous control cycle is smaller than the desired duty cycle in the current control cycle.

The heater pattern determiner 123 changes the duty cycle as illustrated in FIG. 6 when the desired duty cycle in the current control cycle is larger than the duty cycle in the previous control cycle. In this control, switching the duty-cycle limiting range from the minimum duty-cycle limiting range W11 to the maximum duty-cycle limiting range W13 via the medium duty-cycle limiting range W12 greatly reduces the occurrence of the flicker and the inrush current.

FIG. 6 illustrates an example when the heater 53 is turned on. One control cycle includes six half-waves. The desired duty cycles in the first to fifth control cycles are 0%, 100%, 100%, 100%, and 100%, respectively. In addition, in the example of FIG. 6, the two switching thresholds TH1 and TH2 to switch the duty-cycle limiting range are 10% and 60%, respectively. The three duty-cycle limiting ranges W11, W12, and W13 that limit the change in the duty cycle are 10%, 25%, and 40%, respectively.

When the heater 53 is turned on, the duty cycle in the first control cycle is 0% as illustrated in FIG. 6. At a transition timing from the first control cycle to the second control cycle, the duty cycle in the previous control cycle is smaller than the switching threshold TH1 to switch the duty-cycle limiting range that limits the change in the duty cycle. As a result, the duty-cycle limiting range W11 that is relatively smallest among duty-cycle limiting ranges is used, and the duty cycle is increased by 10% in the transition timing under the above-described conditions. As a result, the duty cycle in the second control cycle is 10%.

At transition timings from the second control cycle to the third control cycle and from the third control cycle to the fourth control cycle, the duty cycle in the previous control cycle is equal to or larger than the switching threshold TH1 and smaller than TH2. As a result, the duty-cycle limiting range W11 is switched to the second smallest duty-cycle limiting range W12, and the duty cycle is increased by 25% in each transition timing. As a result, the duty cycle in the fourth control cycle is 60%.

At a transition timing from the fourth control cycle to the fifth control cycle, the duty cycle in the previous control cycle is equal to or larger than the switching threshold TH2 to switch the duty-cycle limiting range that limits the change in the duty cycle. As a result, the duty-cycle limiting range W13 that is relatively largest among duty-cycle limiting ranges is used, and the duty cycle is increased by 40%. Finally, the duty cycle in the fifth control cycle is 100%, which is the same as the desired duty cycle.

FIG. 7 is a diagram illustrating control that switches the duty-cycle limiting range among three types of duty-cycle limiting ranges W11, W12, and W13 based on two types of switching thresholds TH1 and TH2 when the duty cycle in the previous control cycle is larger than the desired duty cycle in the current control cycle.

The heater pattern determiner 123 changes the duty cycle as illustrated in FIG. 7 when the desired duty cycle in the current control cycle is smaller than the duty cycle in the previous control cycle. In this control, switching the duty-cycle limiting range from the maximum duty-cycle limiting range W13 to the minimum duty-cycle limiting range W11 via the medium duty-cycle limiting range W12 based on the two types of switching threshold TH1 and TH2 greatly reduces the occurrence of the flicker and the inrush current.

FIG. 7 illustrates an example when the heater 53 is turned off. One control cycle includes six half-waves. The desired duty cycles in the first to fifth control cycles are 100%, 0%, 0%, 0%, and 0%, respectively. In addition, in the example of FIG. 7, the two switching thresholds TH1 and Th2 to switch the duty-cycle limiting range are 10% and 60%, respectively. The three duty-cycle limiting ranges W11, W12, and W13 that limit the change in the duty cycle are 10%, 25%, and 40%, respectively.

When the heater 53 is turned off, the duty cycle in the first control cycle is 100% as illustrated in FIG. 7.

At a transition timing from the first control cycle to the second control cycle, the duty cycle in the previous control cycle is larger than the switching threshold TH2 to switch the duty-cycle limiting range that limits the change in the duty cycle. As a result, the duty-cycle limiting range W13 that is relatively largest among the duty-cycle limiting ranges is used, and the duty cycle is decreased by 40% in the transition timing under the above-described conditions. As a result, the duty cycle in the second control cycle is 60%.

At transition timings from the second control cycle to the third control cycle and from the third control cycle to the fourth control cycle, the duty cycle in the previous control cycle is larger than the switching threshold TH1 and equal to or smaller than TH2. As a result, the duty-cycle limiting range W13 is switched to the second largest duty-cycle limiting range W12, and the duty cycle is decreased by 25% in each transition timing. As a result, the duty cycle in the fourth control cycle is 10%.

At a transition timing from the fourth control cycle to the fifth control cycle, the duty cycle in the previous control cycle is equal to or larger than the switching threshold TH1 to switch the duty-cycle limiting range that limits the change in the duty cycle. As a result, the duty-cycle limiting range W12 is switched to the duty-cycle limiting range W11, which is relatively smallest among the duty-cycle limiting ranges is used, and the duty cycle is decreased by 10%. Finally, the duty cycle in the fifth control cycle is 0%, which is the same as the desired duty cycle.

As illustrated in FIGS. 6 and 7, the heater controller 100 according to the present embodiment includes the heater pattern determiner 123 (in particular, the duty cycle limiter 124) having multiple duty-cycle limiting ranges that limit the change in the duty cycle of the heater 53, preferably, three or more duty-cycle limiting ranges W11, W12, and W13. The above-described control can contribute to reducing the inrush current in the heater 53, preventing the flicker from occurring, and enhancing the fixing performance.

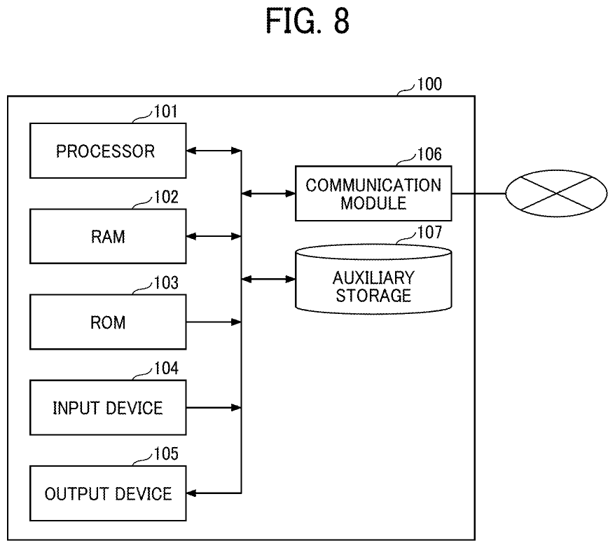

FIG. 8 is a block diagram illustrating a hardware configuration of the heater controller 100. As illustrated in FIG. 8, the heater controller 100 is physically configured as a control board or a computer system. The control board or the computer system includes a processor 101 including a central processing unit (CPU) or a graphics processing unit (GPU), a random-access memory (RAM) 102 and a read-only memory (ROM) 103 that are main memory, an input device 104 such as a keyboard and a mouse, an output device 105 such as a display, a communication module 106 that is a device to send and receive data such as a network card, and an auxiliary storage 107 such as a hard disk drive. Functions of the heater controller 100 described with reference to FIG. 2 are achieved as follows. Hardware such as the processor 101 and the RAM 102 reads computer software, and the processor 101 controls the input device 104, the output device 105, and the communication module 106 to operate them and reads and writes data in the RAM 102 and the auxiliary storage 107 to achieve the functions.

A heater controller includes: circuitry configured to: determine: multiple duty-cycle limiting ranges (W1, W2) to limit change in a duty cycle of a heater (53) from a previous control cycle to a current control cycle; a switching threshold (TH) to switch the multiple duty-cycle limiting ranges; and heater driving patterns including a portion from 0% to 100% of a half wave of an alternating current voltage applied to the heater; determine a desired duty cycle based on: the temperature data of an object to be heated; and a target temperature; select one of the multiple duty-cycle limiting ranges (W1, W2) based on: the duty cycle in the previous control cycle; and the switching threshold (TH); determine a duty cycle in the current control cycle based on: the duty cycle in the previous control cycle; and the duty-cycle limiting range (W1, W2) selected; extract a heater driving pattern from the heater driving patterns based on the duty cycle in the current control cycle; and control the heater based on the heater driving pattern extracted.

The multiple duty-cycle limiting ranges include: a first duty-cycle limiting range (W1); and a second duty-cycle limiting range (W2) larger than the first duty-cycle limiting range, and the circuitry is further configured to: determine whether the duty cycle in the previous control cycle is equal to or larger than the switching threshold (S7), when the duty cycle in the previous control cycle is equal to or larger than the desired duty cycle (S3, NO), switch the first duty-cycle limiting range (W1) to the second duty-cycle limiting range (W2, S9), when the duty cycle in the previous control cycle is larger than the switching threshold (S7, YES), and add the second duty-cycle limiting range (W2) to the duty cycle in the previous control cycle to obtain the duty cycle in the current control cycle (S10).

The multiple duty-cycle limiting ranges include: a first duty-cycle limiting range (W1); and a second duty-cycle limiting range (W2) larger than the first duty-cycle limiting range, and the circuitry is further configured to: determine whether the duty cycle in the previous control cycle is equal to or larger than the switching threshold (S6), when the duty cycle in the previous control cycle is smaller than the desired duty cycle (S3, YES), switch the second duty-cycle limiting range (W2) to the first duty-cycle limiting range (W1, S8), when the duty cycle in the previous control cycle is smaller than the switching threshold (S6, NO), and subtract the first duty-cycle limiting range (W1) from the duty cycle in the previous control cycle to obtain the duty cycle in the current control cycle (S10).

The circuitry is further configured to: determine whether the duty cycle in the previous control cycle is equal to or smaller than the switching threshold (S6), when the duty cycle in the previous control cycle is smaller than the desired duty cycle (S3, YES), switch the second duty-cycle limiting range (W2) to the first duty-cycle limiting range (W1, S8), when the duty cycle in the previous control cycle is smaller than the switching threshold (S6, NO), and subtract the first duty-cycle limiting range (W1) from the duty cycle in the previous control cycle to obtain the duty cycle in the current control cycle (S10).

The circuitry is further configured to: store multiple switching thresholds including the switching threshold; and select one of the multiple duty-cycle limiting ranges based on one of: the multiple switching thresholds; and the duty cycle in the previous control cycle. An image forming apparatus includes: a fixing device including a heater; and the heater controller.

A heater control method includes: determining: multiple duty-cycle limiting ranges (W1, W2) to limit change in a duty cycle of a heater (53) from a previous control cycle to a current control cycle; a switching threshold (TH) to switch the multiple duty-cycle limiting ranges; and heater driving patterns each including a portion from 0% to 100% of a half wave of an alternating current voltage applied to the heater; determining a desired duty cycle based on: the temperature data of an object to be heated; and a target temperature; selecting one of the multiple duty-cycle limiting ranges (W1, W2) based on: the duty cycle in the previous control cycle; and the switching threshold (TH); determining a duty cycle in the current control cycle based on: the duty cycle in the previous control cycle; and the duty-cycle limiting range (W1, W2) selected; extracting a heater driving pattern from the heater driving patterns based on the duty cycle in the current control cycle; and controlling the heater based on the heater driving pattern extracted.

Embodiments of the present disclosure are described in detail above with reference to the specific examples. However, the present disclosure is not limited to the above. Modifications appropriately modified based on the specific examples by those skilled in the art are included within the scope of this disclosure as long as the modifications include the feature of the present disclosure. The specific elements, their arrangement, conditions, shapes, and other aspects of the aforementioned examples are not limited to those illustrated and may be modified as appropriate. The elements included in each of the aforementioned specific examples can be combined in different ways as appropriate, provided that no technical contradictions arise.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. Heater controller comprising:
circuitry configured to:
determine:
multiple duty-cycle limiting ranges to limit change in a duty cycle of a heater from a previous control cycle to a current control cycle;
a switching threshold to switch the multiple duty-cycle limiting ranges; and
heater driving patterns including a portion from 0% to 100% of a half wave of an alternating current voltage applied to the heater;
determine a desired duty cycle based on:
temperature data of an object to be heated; and
a target temperature;
select one of the multiple duty-cycle limiting ranges based on:
the duty cycle in the previous control cycle; and
the switching threshold;
determine a duty cycle in the current control cycle based on:
the duty cycle in the previous control cycle; and
the one of the multiple duty-cycle limiting ranges selected;
extract a heater driving pattern from the heater driving patterns based on the duty cycle in the current control cycle; and
control the heater based on the heater driving pattern extracted.

2. The heater controller according to claim 1,
wherein the multiple duty-cycle limiting ranges include:
a first duty-cycle limiting range; and
a second duty-cycle limiting range larger than the first duty-cycle limiting range, and
the circuitry is further configured to:
determine whether the duty cycle in the previous control cycle is equal to or larger than the switching threshold,
when the duty cycle in the previous control cycle is equal to or larger than the desired duty cycle,
switch the first duty-cycle limiting range to the second duty-cycle limiting range,
when the duty cycle in the previous control cycle is larger than the switching threshold, and
add the second duty-cycle limiting range to the duty cycle in the previous control cycle to obtain the duty cycle in the current control cycle.

3. The heater controller according to claim 1,
wherein the multiple duty-cycle limiting ranges include:
a first duty-cycle limiting range; and
a second duty-cycle limiting range larger than the first duty-cycle limiting range, and
the circuitry is further configured to:
determine whether the duty cycle in the previous control cycle is larger than the switching threshold,
when the duty cycle in the previous control cycle is smaller than the desired duty cycle,
switch the second duty-cycle limiting range to the first duty-cycle limiting range,
when the duty cycle in the previous control cycle is smaller than the switching threshold, and
subtract the first duty-cycle limiting range from the duty cycle in the previous control cycle to obtain the duty cycle in the current control cycle.

4. The heater controller according to claim 2,
wherein the circuitry is further configured to:
determine whether the duty cycle in the previous control cycle is equal to or smaller than the switching threshold,
when the duty cycle in the previous control cycle is smaller than the desired duty cycle,
switch the second duty-cycle limiting range to the first duty-cycle limiting range,
when the duty cycle in the previous control cycle is smaller than the switching threshold, and
subtract the first duty-cycle limiting range from the duty cycle in the previous control cycle to obtain the duty cycle in the current control cycle.

5. The heater controller according to claim 1,
wherein the circuitry is further configured to:
store multiple switching thresholds including the switching threshold; and
select one of the multiple duty-cycle limiting ranges based on one of:
the multiple switching thresholds; and
the duty cycle in the previous control cycle.

6. An image forming apparatus comprising:
a fixing device including a heater; and
the heater controller according to claim 1.

7. A heater control method comprising:
determining:
multiple duty-cycle limiting ranges to limit change in a duty cycle of a heater from a previous control cycle to a current control cycle;
a switching threshold to switch the multiple duty-cycle limiting ranges; and
heater driving patterns including a portion from 0% to 100% of a half wave of an alternating current voltage applied to the heater;
determining a desired duty cycle based on:
temperature data of an object to be heated; and
a target temperature;
selecting one of the multiple duty-cycle limiting ranges based on:
the duty cycle in the previous control cycle; and
the switching threshold;
determining a duty cycle in the current control cycle based on:
the duty cycle in the previous control cycle; and
the one of the multiple duty-cycle limiting ranges selected;
extracting a heater driving pattern from the heater driving patterns based on the duty cycle in the current control cycle; and
controlling the heater based on the heater driving pattern extracted.
